(19) United States
(12) Patent Application Publication
(10) Pub. No.: US 2013/0217338 A1
(43) Pub. Date: Aug. 22, 2013

(54) METHOD OF MULTI-TARGET SWITCH TRANSMISSION THROUGH AN EXTERNALLY CONNECTED BLUETOOTH SELECTION DEVICE

(71) Applicant: Zippy Technology Corp., (US)

(72) Inventor: Chin-Wen CHOU, New Taipei City (TW)

(73) Assignee: Zippy Technology Corp., New Taipei City (TW)

(21) Appl. No.: 13/853,563

(22) Filed: Mar. 29, 2013

Related U.S. Application Data
(63) Continuation-in-part of application No. 12/717,479, filed on Mar. 4, 2010.

(51) Int. Cl. H04W 76/02

(52) U.S. Cl. CPC H04W 76/025
USPC 455/41.2

(57) ABSTRACT

A method of multi-target switch transmission through an externally connected Bluetooth selection device aims to switch at least one input module having a wired connection mode to connect with a first information device and a wireless connection mode to connect with one of at least two second information devices. The method of switch transmission includes the steps of: establishing device connection, setting multi-target devices, determining wired connection mode or wireless connection mode, and determining the second information devices to be connected under the wireless connection mode. Through the externally connected Bluetooth selection device the input module can be switched and usable on the first information device and second information devices at the same time, and also establish connection with the corresponding information device according to requirements.

This application is a continuation-in-part, and claims priority, of from U.S. patent application Ser. No. 12/717,479 filed on Mar. 4, 2010, entitled “MULTI-OBJECT SWITCH TRANSMISSION METHOD”, the entire contents of which are hereby incorporated by reference.

### FIELD OF THE INVENTION

The present invention relates to a method of multi-target switch transmission through an externally connected Bluetooth selection device and particularly to a method of switch transmission through switching of an externally connected Bluetooth selection device to transmit input information with multiple information devices,

### BACKGROUND OF THE INVENTION

Portable information devices have become very popular in recent years. Nowadays, a wide variety of portable information devices, such as smart phones, tablet computers or personal digital assistants (PDAs) are ubiquitous everywhere. Take a smart phone as an example, its data processing capability and convenience have greatly changed people's life style. The general smart phone does not have a keyboard for command signal entry, but generates command signals through a user's tactile contact on a touch panel. In order to improve the convenience of the smart phone, the touch panel often is designed at a smaller size, generally between three inches to five inches. Such a design makes fast input of the command signals difficult.

On the other hand, short distance communication technology is well developed now. Many portable information devices are equipped with a wireless communication module to do short distance communication. The most commonly adopted short distance communication technology is Bluetooth. It has desirable features such as shorter response time and encrypted transmission. Hence some producers have connected the conventional keyboard to the portable information device through Bluetooth. For instance, U.S. patent gazette No. US2012/0302169 discloses a Bluetooth data transmission system and method that includes a computer with a built-in resident program incorporated with a USB Dongle when in use. The USB Dongle is inserted into a USB port of the computer. The built-in resident program intercepts data input from a keyboard connected to the computer and converts the data to a USB format, then the USB Dongle serves as a Bluetooth wireless adapter to send the data to a portable information device mating and connecting to the USB Dongle. While the aforesaid technique can connect a keyboard to a portable information device through Bluetooth, the USB dongle has to be inserted into the USB port beforehand. In other words, the USB Dongle must be activated by the computer through the USB port. But in practice the USB Dongle is not always compatible with every computer, and depends on the USB specification. As a result, not every user can get smooth implementation after purchase. Moreover, the USB dongle has to be incorporated with the built-in resident program when in use, i.e., incorporated with the computer, and the built-in resident program consumes a portion of processing function of the computer that affects the processing performance.

In addition, the devices now commonly equipped with Bluetooth mainly focus on transmission with paired single device, and does not fully take the advantage of selective switch connection among multiple devices within a certain communication range that is available on Bluetooth. There is still room for improvement in terms of application scope and adaptable information products.

### SUMMARY OF THE INVENTION

The primary object of the present invention is to provide a method of multi-target switch transmission to transmit command signals with multiple information devices through an externally connected Bluetooth selection device by switching between a wired connection mode and a wireless connection mode without the need of incorporating with a built-in resident program.

To achieve the foregoing object the invention provides a method of multi-target switch transmission through an externally connected Bluetooth selection device to switch to at least one input module a wired connection mode to connect with a first information device and a wireless connection mode to connect with one of at least two second information devices. The method of switch transmission includes the steps as follow:

Step 1: Establish device connection: Provide an externally connected Bluetooth selection device which includes at least a first connection port connected to the input module, a second connection port connected to the first information device through a wired connection mode, and a wireless communication module connected to the second information device through a wireless connection mode;

Step 2: Set multi-target devices: The externally connected Bluetooth selection device performs a multi-target detection mode via the wireless communication module to search the second information devices which are capable of connection in Bluetooth within the effective connection range of the wireless communication module. The wireless communication module gets at least a device identification code and a device authorization code of the at least two second information devices. The externally connected Bluetooth selection device includes a micro-control unit to produce the device selection code corresponding the device identification code and device authorization code, and has a first switch mode to switch the device selection code to select the corresponding second information devices;

Step 3: Determine wired connection mode or wireless connection mode: Through a second switch mode to determine activation of the wired connection mode or wireless connection mode of the micro-control unit. If the wired connection mode is activated the micro-control unit disables the wireless communication module and establishes connection with the first information device via the wired connection mode. If the wireless connection mode is activated, the micro-control unit disables activation of the wireless communication module at the second connection port and establishes connection with the input module via the wireless connection mode;

Step 4: Determine the connecting second information devices under the wireless connection mode: Determine the device selection mode via the first switch mode, and read the corresponding device identification code and device authorization code via the micro-control unit, and establish connection with the second information devices corresponding to the device selection code through the wireless communication module.

In one embodiment the wired connection mode is a USB transmission mode.

In another embodiment the wireless connection mode is a Bluetooth transmission mode.

In yet another embodiment the step 1 further includes the following sub-steps: a. Judge input module: The micro-control unit judges the input module connecting to the first connection port being a mouse or a keyboard; b. Convert command signals: Convert a command signal input from the input module via the micro-control module to a common format command signal.

In yet another embodiment the first switch mode can be a selection unit located in the externally connected Bluetooth selection device. The selection unit is triggered to generate a selection signal to determine the device selection code. In yet another embodiment the step 3 further includes the following sub-steps: a. detect the first information device: Detect the first information device connected to the second connection port via the micro-control unit to generate an electric connection signal. The micro-control unit detects existing of the electric connection signal and implements the wired connection mode at a higher priority; b. convert connection mode: when the micro-control unit detects no electric connection signal, the wireless connection mode is carried out.

In yet another embodiment the second switch mode is that a switch signal is generated by depressing at the same time a function switch key incorporating with a key on the input module; the switch signal switches the wired connection mode and wireless connection mode.

In yet another embodiment the second switch mode is that the externally connected Bluetooth selection device includes a mode switch unit located. The mode switch unit is triggered to generate a switch signal to drive the micro-control unit to activate the wireless communication module or first connection port.

In yet another embodiment the externally connected Bluetooth selection device includes an activation unit which is connected to the micro-control unit and orders the micro-control unit to activate the first connection port through a third switch mode under the wired connection mode.

In yet another embodiment the method of the invention further includes a step 5 of adding multi-target devices after the step 3: Re-activate the multi-target detection mode, and add the device selection code corresponding to the device identification code and device authorization code of the newly added second information devices.

In yet another embodiment the externally connected Bluetooth selection device includes a memory unit connected to the micro-control unit to save the device selection code, device identification code and device authorization code.

In yet another embodiment the externally connected Bluetooth selection device includes a multi-target detection unit connected to the micro-control unit and triggered to generate a target detection signal to make the micro-control unit to drive the wireless communication module to perform the multi-target detection mode.

In yet another embodiment the first information device is a computer or a portable computer.

In yet another embodiment the second information device is a computer, a portable computer or a tablet computer.

Compared with the conventional techniques, the method of multi-target switch transmission through an externally connected Bluetooth selection device of the invention provides the following features:

1. No need to incorporate with a built-in resident program: The externally connected Bluetooth selection device is externally connected to the first information device. During implementation there is no need to intercept and analyze the command signal entered from the input module through the first information device, hence the processing performance of the first information device is not consumed or affected.

2. Multiple second information devices can be connected at the same time. The externally connected Bluetooth selection device can register the mated and connected second information devices through the device selection code and switch connection among them.

3. The input module with merely a wired connection mode can transmit command signals in a wireless fashion. By connecting the input module to the externally connected Bluetooth selection device which contains the wireless communication module, wireless transmission can be realized.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic block diagram of unit composition of the externally connected Bluetooth selection device of an embodiment according to the method of the invention.

FIG. 2 is a schematic view of the externally connected Bluetooth selection device of an embodiment according to the method of the invention.

FIG. 3 is a process flowchart of an embodiment according to the method of the invention.

FIG. 4 is a schematic view of protocol data fields of an embodiment according to the method of the invention.

FIG. 5 is a schematic view of the externally connected Bluetooth selection device of another embodiment according to the method of the invention.

FIG. 6 is a process flowchart of the sub-steps included in the first step according to an embodiment of the invention.

FIG. 7 is a process flowchart of the sub-steps included in the third step according to an embodiment of the invention.

FIG. 8 is a process flowchart of another embodiment according to the method of the invention.

### DETAILED DESCRIPTION OF THE PREFERRED EMBODIMENTS

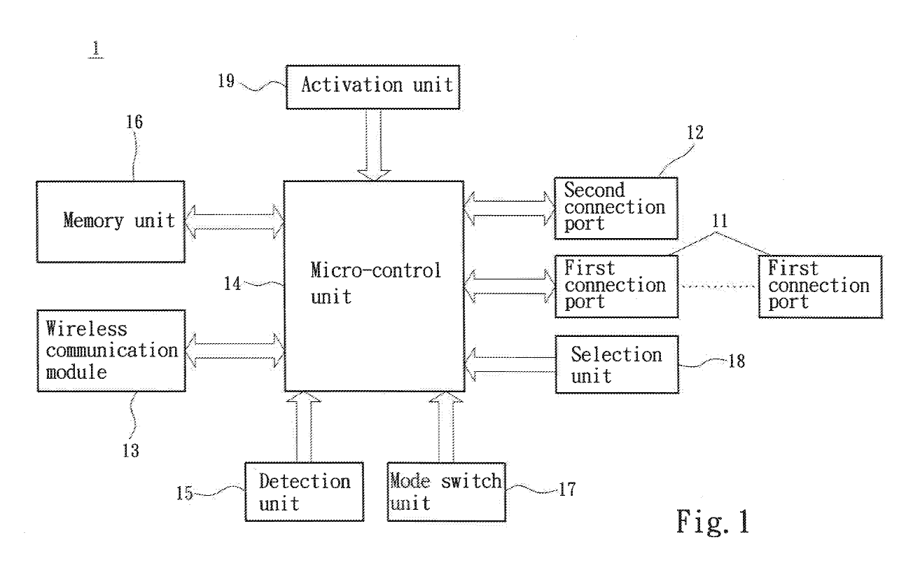

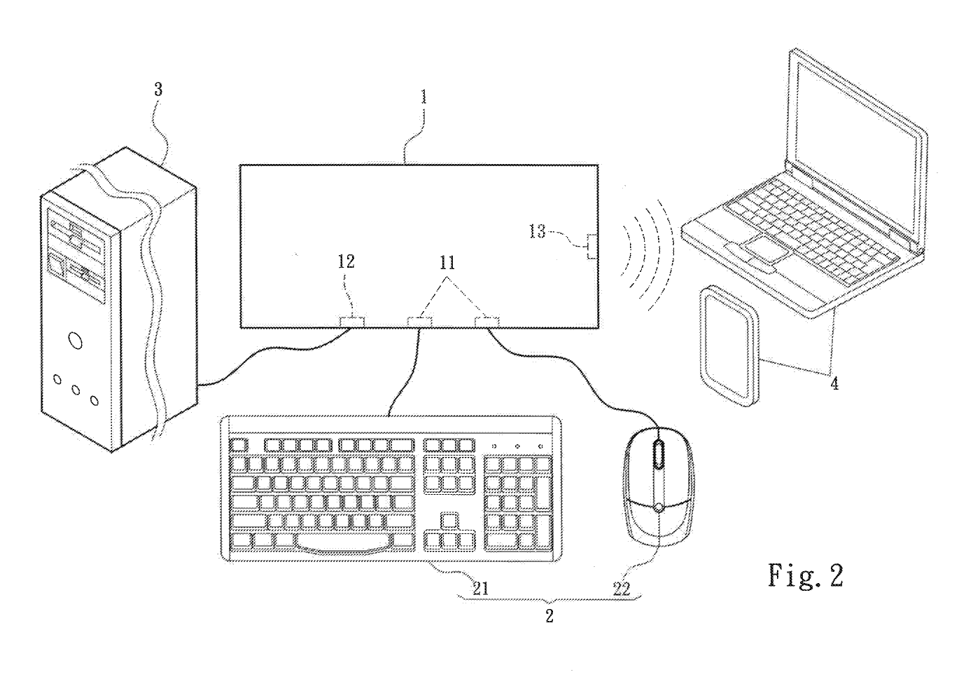

Please referring to FIGS. 1 and 2, the present invention aims to provide a method of multi-target switch transmission through an externally connected Bluetooth selection device 1 to switch at least one input module 2 to connect with a first information device 3 via a wire connection mode or connect connection with one of at least two second information device 4 via a wireless connection mode. The externally connected Bluetooth selection device 1 comprises a first connection port 11 connected to the input module 2, a second connection port 12 connected to the first information device 3 via the wired connection mode, a wireless communication module 13 connected to the second information device 4 via the wireless connection mode, a micro-control unit 14 connected to the first connection port 11, second connection port 12 and wireless communication module 13. More specifically, the wired connection mode can be a USB transmission mode, and the wireless connection mode can be a Bluetooth transmission mode, The input module 2 can be a keyboard 21 or a mouse 22. In the embodiments of the invention, the input module 2, whether being the keyboard 21 or mouse 22, can be connected to the first connection port 11 via the wired connection mode to establish a connection, and through the Bluetooth selection device 1 to establish connection with the second information device 4 via the wireless connection mode. On the other hand, the first information device 3 and second information device 4 can be many other types of devices, not limited to what have been depicted in FIG. 2. The first information device 3 can be a computer or a portable computer. The second information device 4 can be the computer, portable computer, a portable phone or a tablet computer.

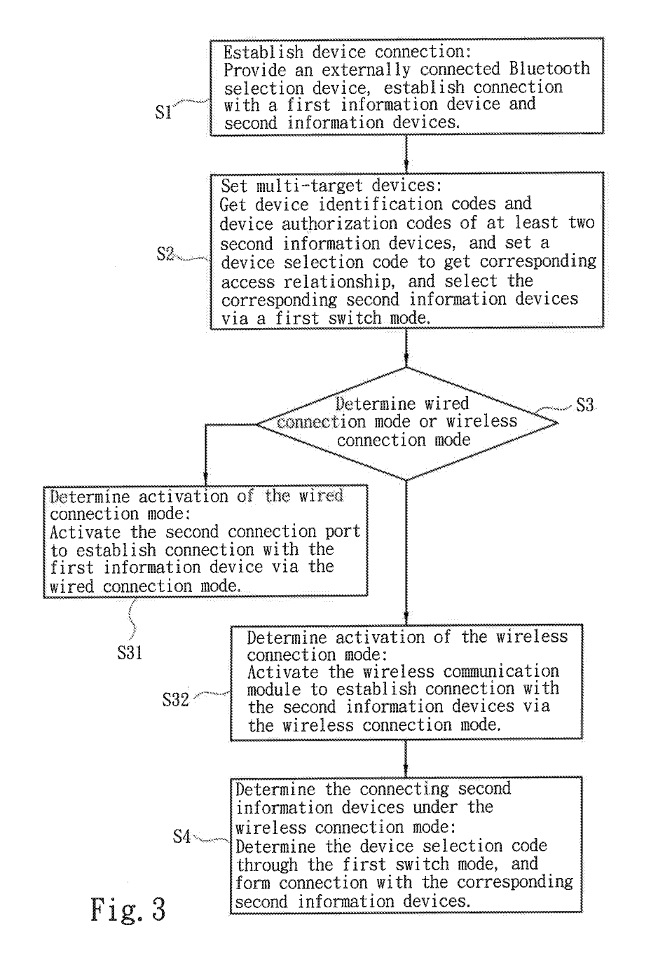

Also referring to FIG. 3, the method of the invention is carried out via the following steps:

Step 1 (S1): Establish device connection;

Step 2 (S2): Set multi-target device;

Step 3 (S3): Determine wired connection mode or wireless connection mode;

Step 4 (S4): Determine the connecting second information device under the wireless connection mode.

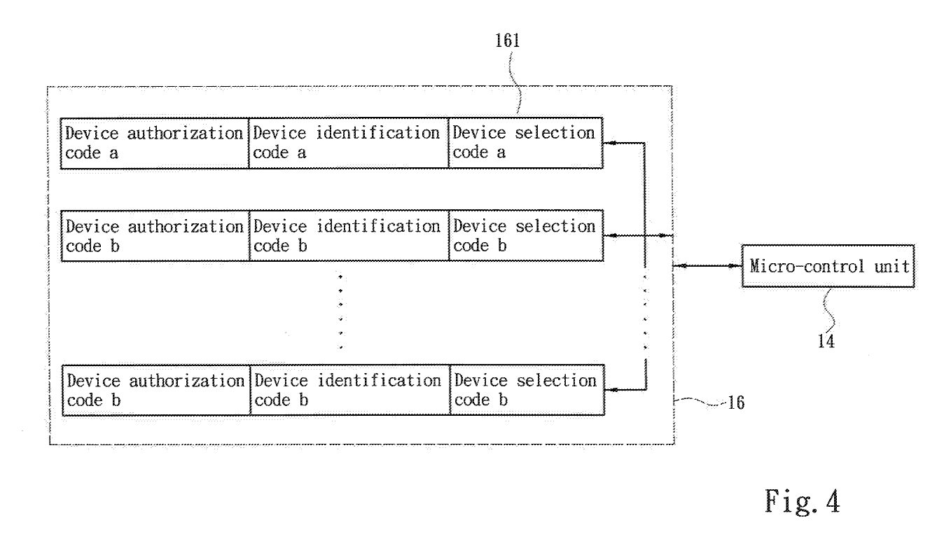

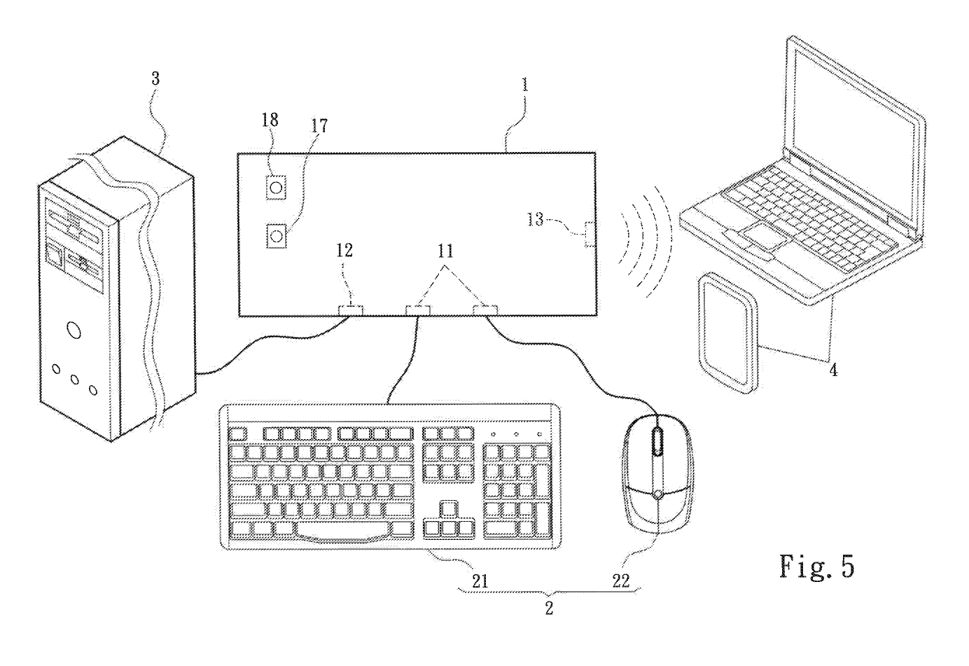

More specifically, at step S1, provide the externally connected Bluetooth selection device 1 which includes at least a first connection port 11 connected to the input module 2, a second connection port 12 connected to the first information device 3 via the wired connection mode, and a wireless communication module 13 connected to the second information devices 4 via the wireless connection mode. In other words, the externally connected Bluetooth selection device 1 establishes connection with the input module 2 via the first connection port 11 which is connected to the first information device 3 through the wired connection mode, then is connected to the second information device 4 via the wireless communication module 13 through the wireless connection mode. Then enter step S2, the externally connected Bluetooth selection device 1 performs a multi-target detection mode via the wireless communication module 13 to search the second information device 4 matching the Bluetooth within the effective connection range, at the same time the wireless communication module 13 gets a device identification code and a device authorization code of the two second information devices 4, and the micro-control unit 14 sets up a device selection code corresponding to the device identification code and device authorization code; and also selects the corresponding second information device 4 by switching the device selection code via a first switch mode. More specifically, the externally connected Bluetooth selection device 1 can include a detection unit 15 connected to the micro-control unit 14 and triggered to generate a target detection signal to order the micro-control unit 14 to drive the wireless communication module 13 to perform the multi-target detection mode, i.e., the externally connected Bluetooth selection device 1 can carry out the multi-target detection mode by triggering the detection unit 15. On the other hand, the device identification code can be the so-called Bd_address in Bluetooth, and the device authorization code can be the so-called pin_code in Bluetooth. The externally connected Bluetooth selection device 1 can also have a memory unit 16 connected to the micro-control unit 14 to save the device selection code, device identification code and device authorization code. Please also referring to FIG. 4, the invention further includes a protocol data field 161 which sets corresponding relationship between each device selection code, each device identification code and each device authorization code. After the setting is finished, enter step S3 to determine whether the micro-control unit 14 to activate the wired connection mode or wireless connection mode via a second switch mode. When the wired connection mode is activated (Step S31 in FIG. 3), the micro-control unit 14 disables the wireless communication module 13 and establishes connection with the first information device 3 via the wired connection mode. In the event that the wireless connection mode is activated (step S32 in FIG. 3), the micro-control unit 14 disables the second connection port 12 and activates the wireless communication module 13 to establish connection with the input module 2 via the wireless connection mode. Furthermore, the second switch mode can be implemented through two approaches: one, the input module 2 has a function switch key and at least one key that are collaborated and depressible at the same time to generate a switch signal which switches the wired connection mode and wireless connection mode. The switch function key can further be a function key (Fn Key) on the keyboard 21. Another approach is providing a mode switch unit 17 on the externally connected Bluetooth selection device 1 (please referring to FIG. 5). The mode switch unit 17 can be triggered to generate the switch signal to drive the micro-control unit 14 to activate the wireless communication module 13 or first connection port 11. After the wired connection mode is selected, the externally connected Bluetooth selection device 1 activates the first connection port 11, and the input module 2 outputs a command signal transmitted to the first information device 3 via the first connection port 11. If the wireless connection mode is selected, execute step S4, and determine the device selection code through the first switch mode, the micro-control unit 14 reads the corresponding device identification code and device authorization code, and the wireless communication module 13 establishes connection with the second information device 4 corresponding to the device selection code. More specifically, the first switch mode can include a selection unit 18 located on the externally connected Bluetooth selection device 1. The selection unit 18 is triggered to generate a selection signal to determine the device selection code; through the device selection code the corresponding device identification code and device authorization code are read, then connects to the corresponding second information device 4, and the command signal transmitted by the input module 2 is sent to the second information device 4 via the wireless communication module 13. In addition, the externally connected Bluetooth selection device 1 has an activation unit 19 connected to the micro-control unit 14 to order the micro-control unit 14 to activate the first connection port 11 through a third switch mode under the wired connection mode. The activation unit 19 can be a switch, and the third switch mode can be an operation activity of pressing the activation unit 19.

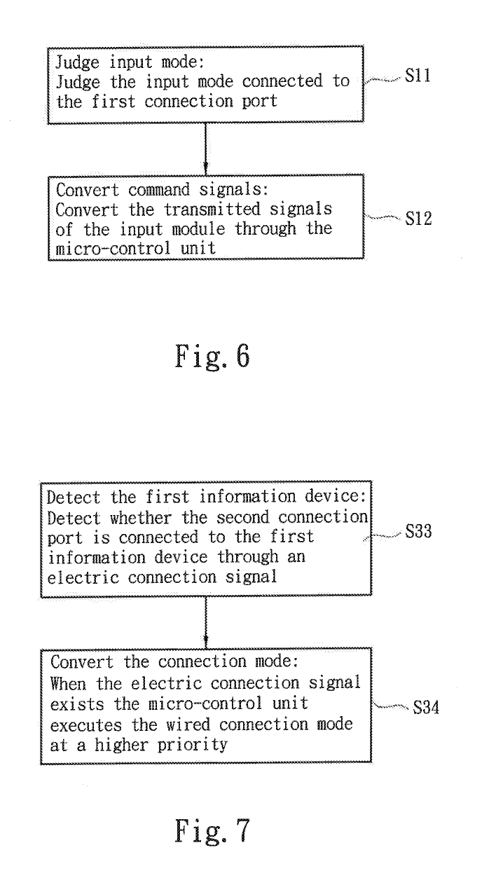

Please referring to FIG. 6, the input module 2 previously discussed can be the keyboard 21 or mouse 22 that output different command signals. Hence the invention further includes the following sub-steps in step 1: S11: judge the input module, and S12: convert command signals. More specifically, while the input module 2 is connected to the first connection port 11, the externally connected Bluetooth selection device 1 judges via the micro-control unit 14 whether the input module 2 connected to the first connection port 11 is the mouse 22 or keyboard 21. After the judgment is finished, enter the next step; the input command signal of the input module 2 is converted via the micro-control unit 14 to a common format input command. More specifically, to achieve the aforesaid object the micro-control unit 14 can be a chip equipped with USB OTG function.

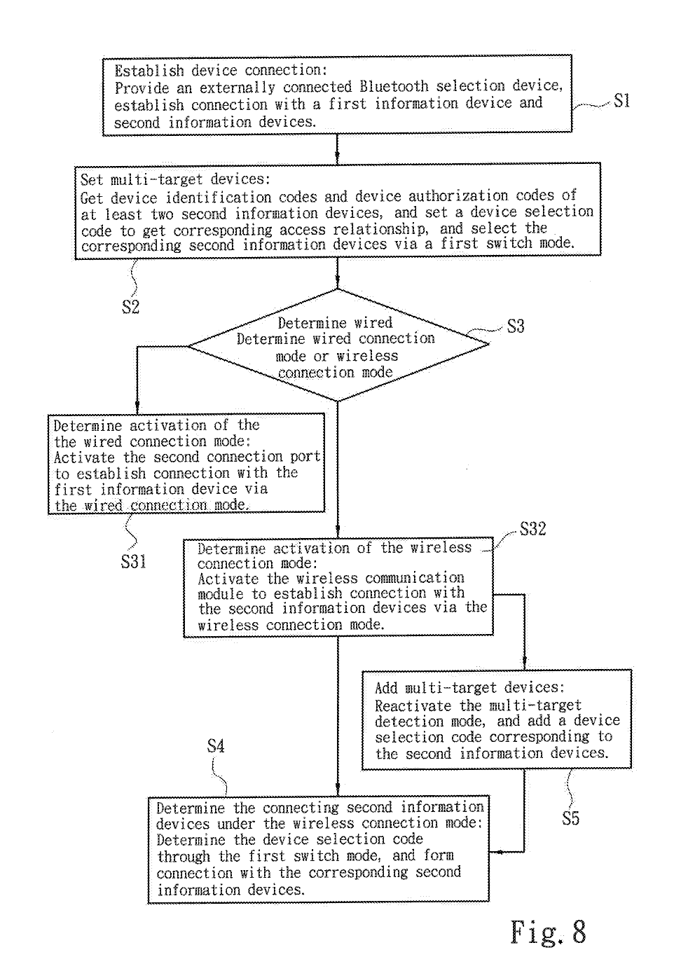

Please referring to FIG. 7, the step 3 of the invention further includes the following sub-steps: S33: detect the first information device; and S34: convert connection mode. More specifically, at the sub-step S33 of detect the first information device, the externally connected Bluetooth selection device 1 detects an electric connection signal resulted from connection of the second connection port 12 and first information device 3 via the micro-control unit 14, then the wired connection mode is carried out at a higher priority. In the event that the micro-control unit 14 detects no electric connection signal, it orders to carry out the wireless connection mode. In other words, at step S3, before the wired connection mode or wireless connection mode is determined via the second switch mode the externally connected Bluetooth selection device I judges in advance whether connection is established with the first information device 3; if the outcome is positive, connection with the first information device via the wired connection mode is acknowledged tacitly; if the outcome is negative, switch to the wireless connection mode. Also referring to FIG. 8, after the step S3 of determining the wired connection mode or wireless connection mode, another step S5 of adding multi-target devices can be included. After the wireless connection mode is determined, reactivate the multi-target detection mode, and search anew the second information device 4 within the effective communication range of the wireless communication module 13 to get the device selection code thereof corresponding to the device identification code and device authorization code to be used by the externally connected Bluetooth selection device 1 for connection.

As a conclusion, the method of the invention switches connection via an externally connected Bluetooth selection device for at least one input module through a wired connection mode with a first information device or one of at least two second information devices through a wireless more. The method of switch transmission includes the steps of establishing device connection, setting multi-target devices, determining wired connection or wireless connection, and determining connection with the second information devices under the wireless connection mode. Through switch of the externally connected Bluetooth selection device the input module is usable on the first information device and second information devices at the same time, and connection can be established with the corresponding information devices according to requirements.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method of multi-target switch transmission through an externally connected Bluetooth selection device to switch at least one input module having a wired connection mode to connect with a first information device and a wireless connection mode to connect with one of at least two second information devices, the method comprising the steps of;
Step 1: establishing device connection by providing an externally connected Bluetooth selection device which includes at least a first connection port connected to the input module, a second connection port connected to the first information device via the wired connection mode and a wireless communication module connected to the second information devices via the wireless connection mode;
Step 2: setting multi-target devices in which the externally connected Bluetooth selection device performs a multi-target detection mode via the wireless communication module to search the second information devices which is capable of connection in Bluetooth within an effective connection range of the wireless communication module, the wireless communication module getting at least two sets of device identification codes and device authorization codes of the second information devices, the externally connected Bluetooth selection device including a micro-control unit to set a device selection code corresponding to the device identification code and the device authorization code, and containing a first switch mode to switch the device selection code to select the corresponding second information devices;
Step 3: determining the wired connection mode or the wireless connection mode through a second switch mode to determine the micro-control unit to activate the wired connection mode or the wireless connection mode; while the wired connection mode is activated the micro-control unit disables the wireless communication module and establishes connection with the first information device via the wired connection mode; while the wireless connection mode is activated the micro-control unit disables the second connection port and activates the wireless communication module to establish connection with the input module via the wireless connection mode; and
Step 4: determining the connection of the second information devices under the wireless connection mode in which the device selection code is determined via the first switch mode and the micro-control unit reads the corresponding device identification code and the device authorization code, and connection is established with the second information device corresponding to the device selection code via the wireless communication module.

2. The method of claim 1, wherein the wired connection mode is a USB transmission mode.

3. The method of claim 1, wherein the wireless connection mode is a Bluetooth transmission mode.

4. The method of claim 1, wherein the step 1 further includes the sub-steps of:
a. judging the input module in which the micro-control unit judges the input module connected to the first connection port being a mouse or a keyboard; and
b. converting command signals in which the micro-control unit converts a command signal input from the input module to a common format command signal.

5. The method of claim 1, wherein the first switch mode includes a selection unit in the externally connected Bluetooth selection device that is triggered to generate a selection signal to determine the device selection code.

6. The method of claim 1, wherein the step 3 further includes the sub-steps of:
a. detecting the first information device in which the micro-control unit detects an electric connection signal generated by connection of the second connection port and the first information device and performs the wired connection mode at a higher priority; and
b. converting the connection mode when the micro-control unit detects no electric connection signal and performs the wireless connection mode thereof.

7. The method of claim 1, wherein the second switch mode is that the input module includes a function switch key and at least one key, the function switch key collaborating with the key that are depressible at the same time to generate a switch signal to switch the wired connection mode and the wireless connection mode.

8. The method of claim 1, wherein the second switch mode is that the externally connected Bluetooth selection device includes a mode switch unit, the mode switch unit being triggered to generate a switch signal to drive the micro-control unit to activate the wireless communication module or the first connection port.

9. The method of claim 1, wherein the externally connected Bluetooth selection device includes an activation unit connected to the micro-control unit to activate the first connection port via a third switch mode under the wired connection mode.

10. The method of claim 1 further including a step 5 of adding multi-target devices after the step 3 by reactivating the multi-target detection mode and adding the device selection code corresponding to the device identification code and the device authorization code of the newly added second information devices.

11. The method of claim 1, wherein the externally connected Bluetooth selection device includes a memory unit connected to the micro-control unit to save the device selection code, the device identification code and the device authorization code.

12. The method of claim 1, wherein the externally connected Bluetooth selection device includes a detection unit connected to the micro-control unit and triggered to generate a target detection signal to order the micro-control unit to drive the wireless communication module to perform the multi-target detection mode.

13. The method of claim 1, wherein the first information device is selected from the group consisting of a computer and a portable computer.

14. The method of claim 1, wherein the second information devices are selected from the group consisting of a computer, a portable computer and a tablet computer.
